(19) United States
(12) Patent Application Publication
(10) Pub. No.: US 2025/0177853 A1
(43) Pub. Date: Jun. 5, 2025

(54) SYSTEMS AND METHODS FOR CONTENT QUALITY SCALING AND ATTENTION TRACKING

(71) Applicant: Sony Interactive Entertainment INC., Tokyo (JP)

(72) Inventors: Glenn Black, San Francisco, CA (US); Jin Zhang, San Mateo, CA (US)

(73) Assignee: Sony Interactive Entertainment INC., Tokyo (JP)

(21) Appl. No.: 18/530,145

(22) Filed: Dec. 5, 2023

(51) Int. Cl. A63F 13/25; G06F 3/01

(52) U.S. Cl. CPC A63F 13/25; G06F 3/013; G09G 2340/0407

(57) ABSTRACT

System, process, and device configurations are provided for content quality scaling and attention tracking. A method can include presenting electronic game content on a display and detecting a user attention parameter for the electronic game content. The user attention parameter may be used as an estimate of user focus and for controlling a presentation format of the electronic game content including modifying presentation of electronic game content. At least one of audio and video components of electronic game content may be modified, such as scaling size of elements, controlling display resolution, controlling display of a portion of a screen and controlling directed audio. In addition to detecting focus, configurations and processes may be used to generate game rewards based on maintained focus. Processes may be used to promote focus, provide feedback and improve device operation by reducing processing load.

### FIELD

The present disclosure is directed to systems and methods for content quality scaling and interactive entertainment control, including electronic game control, game content rendering, gaming device operations, and gaming device processes.

### BACKGROUND

Computer and console game titles have been developed in many styles for different gaming systems and platforms. As device processing increases and game environments become more immersive, there is a desire for enhancement of content and customization of content for users. There also exists a desire to leverage entertainment functionality to improve features provided to users. Users have a varying spectrum of needs and game play styles. There is a desire to detect user interaction with game content for providing feedback. While poor game play can lead to a lower score, additional game tasks or repeating a game environment, there is a desire for providing user feedback in response to player attention. There is also a desire to provide game functions based on player attention. As such, there is also a desire for configurations and processes that allow for control of electronic game output.

### BRIEF SUMMARY OF THE EMBODIMENTS

Disclosed and described herein are systems, methods and device configurations for content quality scaling and attention tracking. In one embodiment, a method includes controlling, by a device, electronic game content presentation on a display, and detecting, by the device, a user attention parameter relative to the electronic game content, wherein the user attention parameter includes an estimate of user focus on the electronic game content presentation. The method also includes controlling, by the device, a presentation format for the electronic game content based on the user attention parameter, wherein the presentation format modifies the electronic game content presentation. The method also includes outputting, by the device, the electronic game content using the presentation format.

In one embodiment, the electronic game content is presented including at least one of audio and video content, and wherein the presentation format scales output of the at least one of the audio and video content.

In one embodiment, the user attention parameter is detected based on eye tracking data captured of a user during presentation of the electronic game content.

In one embodiment, the user attention parameter is determined based on at least one of camera data, eye tracking data, user accelerometer data, and content interaction data.

In one embodiment, the user attention parameter tracks user focus relative to at least one of a user controlled game element and a target of the electronic game.

In one embodiment, controlling the presentation format includes reducing output quality of at least one display area of the electronic game content based on the user attention parameter.

In one embodiment, controlling the presentation format includes scaling display size of at least one electronic game element image.

In one embodiment, controlling the presentation format includes output of a game reward, wherein the reward is generated in response to user focus meeting a threshold level for a period of time.

In one embodiment, the method further includes detecting a sound level for an environment of the display device, and controlling game content output based on environment detected.

In one embodiment, output of the electronic game content includes controlling directive output of electronic game audio based on the sound level of the environment.

Another embodiment is directed to a device configured for content quality scaling and attention tracking. The device includes an interface configured to output gaming content, a memory storing executable instructions and a controller, coupled to the interface and memory. The controller is configured to control electronic game content presentation on a display, and detect a user attention parameter relative to the electronic game content, wherein the user attention parameter includes an estimate of user focus on the electronic game content presentation. The controller is configured to control a presentation format for the electronic game content based on the user attention parameter, wherein the presentation format modifies the electronic game content presentation. The controller is configured to output the electronic game content using the presentation format.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of content quality scaling and attention tracking according to one or more embodiments;

FIG. 2 illustrates a process for content quality scaling and attention tracking according to one or more embodiments;

FIG. 3 illustrates a graphical representation of a device configuration according to one or more embodiments; and

FIGS. 4A-4C are graphical representations of content quality scaling and attention tracking according to one or more embodiments.

### DETAILED DESCRIPTION OF THE EXEMPLARY EMBODIMENTS

### Overview and Terminology

System, process, and device configurations are provided for content quality scaling and attention tracking. Embodiments include device configurations and processes to scale content of an electronic game based on how closely a user is paying attention to game output at a current time. User focus may be assessed and device operation may be modified, and in particular game content output may be modified to provide feedback to a user and training game focus. User focus may also be incentivized by generating rewards for players. In addition to control based on focus, embodiments provide control features for game content output based on environment of a user.

A method can include presenting electronic game content on a display and detecting a user attention parameter for the electronic game content. The user attention parameter may be used as an estimate of user focus and for controlling a presentation format of the electronic game content including modifying presentation of electronic game content. At least one of audio and video components of electronic game content may be modified, such as scaling size of elements, controlling display resolution, controlling display of a portion of a screen and controlling directed audio. Configurations and processes may be used to generate game rewards based on maintained focus. Processes may be used to promote focus, provide feedback and improve device operation by reducing processing load. These rewards can function as a system-wide currency and may be used as in-game rewards for playing well or achieving goals, spent on system level items/games/traded.

System and device configurations are provided including operations performed by an interactive control device, such as a game console, display device, and handheld gaming device. Configurations may also be employed by network device or server to control media output or provide control signals to an interactive control device.

Systems and methods also provide configurations and operations for controlling the output of electronic game content to improve device performance. Some game and media content is computationally expensive. Processor and device load may be improved by reducing content for display for periods of time a user is not focusing on content. Similarly, processor and device load may be improved by reducing content output in a noisy or distracting environment. In addition, improving processor and device load may improve network usage and reduce network load for network applications. According to embodiments, device configurations and process operations may control output, including scaling output, reducing output, limiting output for periods of time to provide a system and methods for content quality scaling based on player attention. For example, content quality may be automatically scaled according to how closely a user is paying attention at any given time. Player attention can be estimated using camera data, eye tracking, accelerometer, ambient audio, content interaction, etc. If a player is visually distracted, video resolution can be reduced, shade bars enabled, rendering distance decreased, etc. If a player is in a loud environment audio fidelity can be decreased, spatial audio disabled, etc.

One aspect of the disclosure is directed to detecting and using user attention data for control and presentation of gaming content. Player attention can be estimated using one or more of camera data, eye tracking data, accelerometer data for a user (worn or held device, etc), ambient audio, content interaction, etc. If a player is visually distracted, video resolution can be reduced, disabled or display areas reduced, rendering distance decreased, etc. If a player is in a loud environment audio fidelity can be decreased, spatial audio disabled, etc.

Embodiments are directed to gaming systems which may include consoles, processors or servers that generate game media and interactive entertainment devices configured to provide output and receive user input. Embodiments are configured to use user attention data for one or more purposes including customization of gaming content and as a mechanism to allow for game functions to be provided to a user. In many cases, the full functionality of gaming content may not be utilized by a user. This may be due to focus on a portion of a screen, being distracted, and/or game play environment. Processes, system configurations and device configurations according to embodiments are provided to allow gaming systems and media players to detect user attention for use in controlling operation of devices and output of gaming content. According to embodiments, user attention parameters may be detected using eye tracking data. By way of example, player engagement parameters may relate to focus, or lack of focus, on game objects to indicate user attention for a particular game title or for gaming content in general. Alternatively, or in combination, user attention parameters from eye tracking data may indicate use of data presented or the need to reduce process load of a device.

Embodiments described herein include processes, device configurations and systems for detecting and using user attention data to effect game audio. According to embodiments, configurations are provided for devices to present gaming content, and to determine one or more user attention parameters using camera data and/or eye tracking data to modify sound output. Embodiments may also be used to amplify, adjust or lower, sound output of an object focused on by a user. Sound control may be updated independent of display objects based on detected eye tracking data. In addition, embodiments include operations and processes for controlling the directionality and sound output based on user attention and/or user environment.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

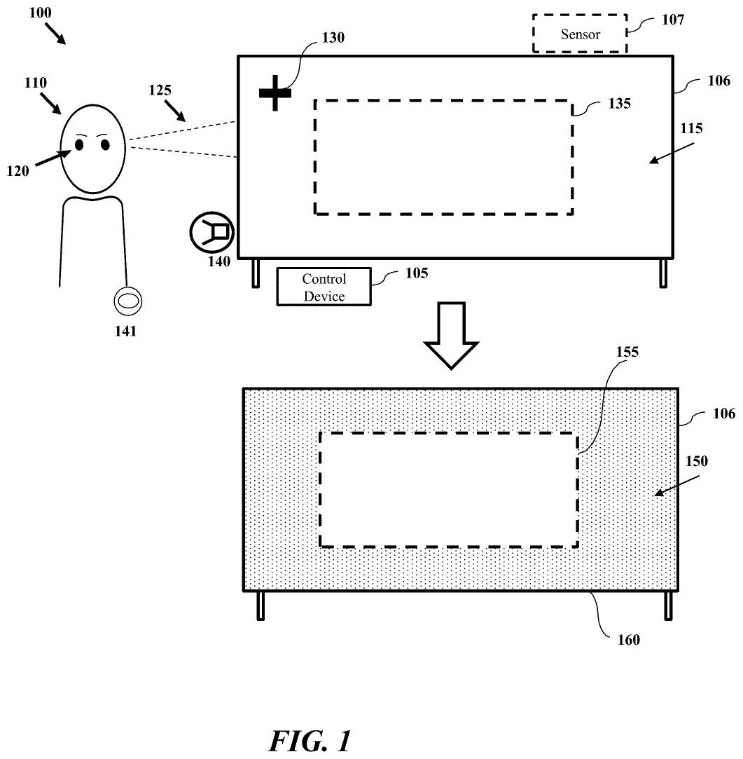

FIG. 1 is a graphical representation of content quality scaling and attention tracking according to one or more embodiments. System 100 may be configured for presenting electronic game content on a display and detecting a user attention parameter for the electronic game content. According to embodiments, one or more devices of system 100 may be configured for content quality scaling and attention tracking. System 100 includes control device 105 which may be configured to control electronic game content presentation on display 106. According to embodiments, control device 105 may be a standalone device, such as a game console or game media player. According to embodiments, control device 105 and display 106 may be parts of the same unit, such as a display device with a processor or a handheld gaming device.

According to embodiments, control device 105 may be configured to detect a user attention parameter, for user 110, relative to the electronic game content. FIG. 1 illustrates game content presentation 115. The user attention parameter can includes an estimate of user focus on the electronic game content presentation. Control device 105 may be configured to control presentation format for the electronic game content based on the user attention parameter. According to embodiments, the presentation format may be modified of the electronic game content presentation using the user attention parameter, and control device 105 may be configured to output the electronic game content using the presentation format. FIG. 1 illustrates game content presentation 115 modified to game content presentation 150. According to embodiments, control device 105 may be configured to perform one or more network operations including communicating with one or more servers on a communication network.

According to embodiments, control device 105 may be configured to control presentation format for the electronic game content based on user attention parameter for one or more users, such as user 110. The user attention parameter may be used as an estimate of user focus and for controlling a presentation format of the electronic game content including modifying presentation of electronic game content. At least one of audio and video components of electronic game content may be modified by control device 105, such as scaling size of elements, controlling display resolution, controlling display of a portion of a screen and controlling directed audio. In addition to detecting focus, configurations and processes of control device 105 may be used to generate game rewards based on maintained focus. Processes may be used to promote focus, provide feedback and improve device operation by reducing processing load.

According to embodiments, user attention may be detected and monitored, with user permission, during output of an electronic game and interactive media in general. According to embodiments, control device 105 relates to a media output device, such as a game console. It should be appreciated that that one or more of a server and display device 106 may be configured to provide electronic game functions, game control and interactive media output. It should also be appreciated that detection of a user attention parameter is not limited to electronic games. The principles of the disclosure may be provided to other forms of network and interactive communication, and device control in general. For purposes of illustration and example of operation, system 100 and control device 105 may detect a user attention parameter for user 110 during presentation of electronic game content 115 by display 106. User 110 may be controlling an electronic game output by control device 105. According to embodiments, one or more elements of system 100 may be used to detect a user attention parameters. According to embodiments, system 100 may include sensor 107 to detect user attention parameters. Sensor 107 may be an image capture device, such as a camera configured to capture images and/or video image date of user 110. According to embodiments, sensor 107 may provide image data to control device 105. Control device 105 may be configured to capture position and features of eyes 120 of user 110 to perform eye tracking. Using image data and eye tracking data, control device 105 may be configured to detect and track one or more of user gaze 125, a focus point, such as focus point 130, and a display area, such as display area 135, a user is viewing. According to embodiments, control device 105 may control output of one or more sound devices, such as speaker 140, of display 106.

According to embodiments, control device 105 may receive output from one or more devices, such as sensor 107 or display 106 when sensor 107 is included as part of display 106. Control device 105 may be configured to detect a user attention parameter relative to the electronic game content 115 on display 106. The user attention parameter can include an estimate of user focus on the electronic game content presentation. According to embodiments, a user attention parameter can include one or more focus points a user is viewing on a display. By way of example, a user attention parameter may include values or data points for locations on display 106 that a user views for longer than a period of time. The user attention parameters may be determined relative to one more references. For example, display area 135 may relate to a primary area, or particular area of display, with game content and user attention outside of the display area may relate to distracted or unfocused attention. The user attention parameter may also include one or more metrics for user eye movement speed, user eye movement patterns and user eye movement indicating a lack of interest.

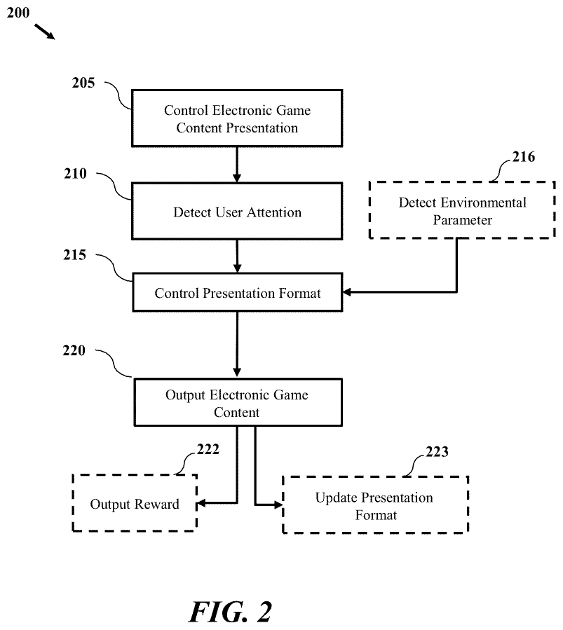

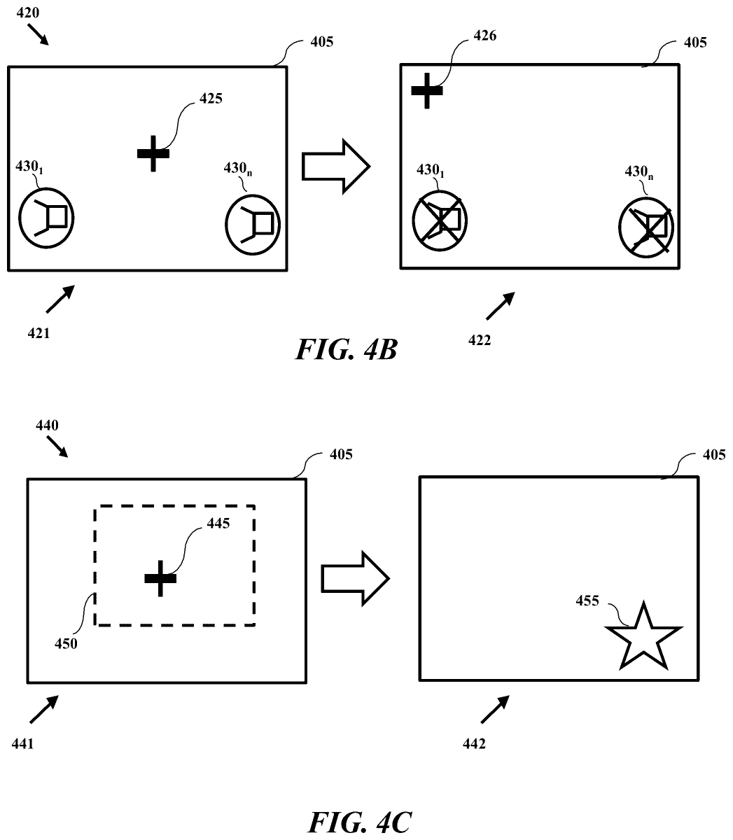

According to embodiments, detection of user attention parameters may be performed using a machine learning language model. Processes for conversion are discussed with reference to FIGS. 2 and 4A-C. According to embodiments, system 100 may be configured to use and update machine learning models.

Based on the user attention parameter, control device 105 may be configured to control a presentation format and the electronic game content using the presentation format. According to embodiments, the presentation format modifies the electronic game content presentation. FIG. 1 illustrates a modified presentation format 150 including a first display area 155, a second display area 155 of display 106. Modified presentation format 150 may relate to an updated version of electronic game content 115.

According to embodiments, modified presentation format 150 may be generated for content quality scaling based on player attention. Process 100 may automatically scale content quality according to how closely a user is paying attention at any given time. According to embodiments, player attention can be estimated using camera data, eye tracking, accelerometer, ambient audio, content interaction, etc. If a player is visually distracted, video resolution can be reduced, shade bars enabled, rendering distance decreased, etc. If a player is in a loud environment, audio fidelity can be decreased, spatial audio disabled, etc. Control device 105 may be configured to generate rewards that function as a system-wide currency and which may be used as in-game rewards for playing well or achieving goals. The rewards for example may be spent on system level items/games/traded.

According to embodiments, modified presentation format 150 can include content in first display area 155 with a first resolution or display format, and content in a second display area 155 of display 106 having a second resolution or display format. For example, a second display area 155 may be presented with reduced quality (e.g., display resolution) when a user attention parameter indicates use gaze and/or focus points within the first display area 155 for a predetermined period of time. According to embodiments, electronic game content in the first display area 155 may be scaled when a user attention parameter indicates a user is distracted or unfocussed. A modified presentation format 150 can include one or more areas of electronic game content on display 106 that are shaded, reduced or modified. Reducing the display quality may provide foveated rendering, wherein displayed content is presented with one or more display resolutions. By reducing display resolution, operations and device configurations can reduce device processing and network load. In addition, reduced rendering may improve device function, to steer processing power to display areas that a user focuses on. By reducing display resolution, power usage of a device may be reduced, especially for large displays. Similarly, modified presentation 150 may be presented for periods of time or alternating periods of time, such as during a user saccade. By way of example, during periods of time between user focus the display may be reduced in one or more areas of the display. By reducing display resolution during a saccade, device performance may be improved.

According to embodiments, control of electronic game output may include controlling sound output 140. One or more of control device 105, display 106 and sensor 107 may be configured to detect environmental or ambient sound of a user. When a player is in a loud environment, control device 105 can modify sound output, such as decreasing audio fidelity, disabling spatial audio, etc. User attention may be detected by one or more control devices, such as device 141 which may be one or more of a handheld device, game controller and wearable. Device 141 may detect user movement and may be controlled as a haptic device to provide feedback to a user.

One or more devices of system 100 may monitor user reactions to modified electronic game output. For user attention that continues to be unfocused, such as not viewing content presented by display 106, a modified format may continue to be displayed. For user attention that regains focus, the output of control device may revert display of content to full resolution. According to embodiments, conversion of communications by system 100 may be performed using a machine learning model. One or more devices of system 100, such as control device 105, and display 106 may perform operations of a machine learning model. According to embodiments, modification of electronic game content may be performed for a user, such as user 110, by one or more devices of system 100, including control device 105 and/or display 106.

System 100 may provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content.

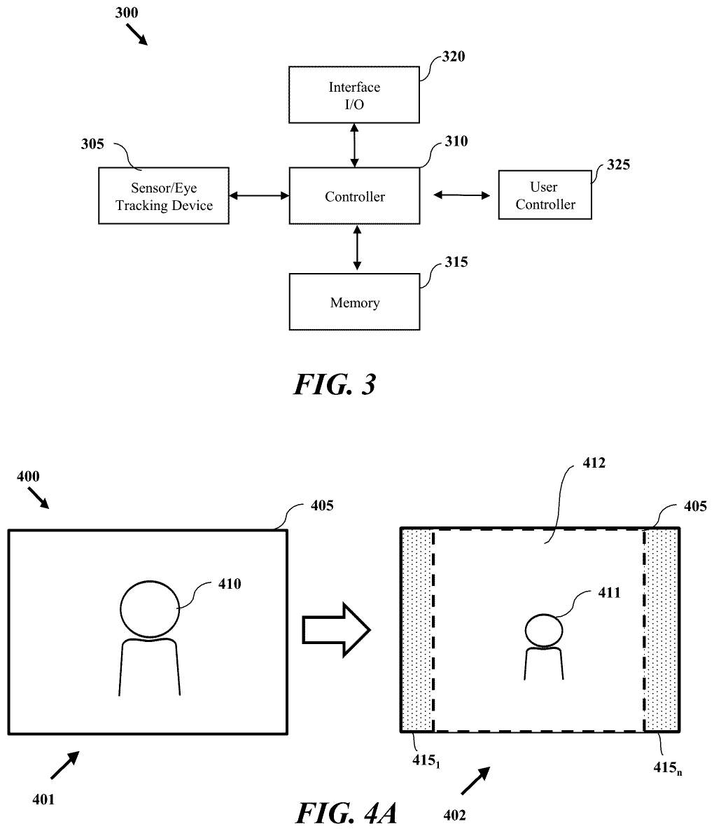

FIG. 2 illustrates a process for content quality scaling and attention tracking according to one or more embodiments. Process 200 may be performed for interactive game control and can include controlling presentation format for the electronic game content based on detected user attention parameters. Process 200 may modify game presentation using user attention parameters, including modifying and/or controlling presentation of content, such as gaming content, gaming video and audio output. Process 200 may be performed by a device, such as device 300 and/or controller 310 of FIG. 3, for at least one of content quality scaling and attention tracking. Process 200 may be initiated by a device (e.g., control device 105, device 305, etc.) controlling electronic game content presentation on a display at block 205. According to embodiments, gaming content may be output to a display (e.g., display 110). According to embodiments, electronic game content is presented at block 205 including at least one of audio and video content. The presentation format can be modified to scale output of the at least one of the audio and video content. Processes and configurations described herein allow for detection of user attention, including eye tracking detection to identify user gaze, objects of interest, and user engagement in general. User attention may detected by one or more control devices, such as hand held devices and wearables.

At block 210, process 200 includes detecting, by the device, a user attention parameter relative to the electronic game content. The user attention parameter can includes an estimate of user focus on the electronic game content presentation. A user attention parameter may be detected based on eye tracking data captured of a user during presentation of the electronic game content. The user attention parameter may be determined based on at least one of camera data, eye tracking data, user accelerometer data, and content interaction data. For example, user attention to gaming content with gaze focus on one or more display areas, one or more game elements, and actions tied to game performance may be determined as having a high level of focus. Alternatively, frequently looking away from a display screen, looking away for a period of time, and/or actions that indicate a low level of interest may be a basis for indicating a low user attention range. The user attention parameter may track user focus relative to at least one of a user controlled game element and a target of the electronic game.

Detecting a user attention parameter can include detecting eye tracking data for the user, eye tracking data may be detected or received from one or more peripheral devices or devices integrated with the gaming device. Eye tracking data can include at least one of a focus point, eye movement, eye movement speed, eye movement frequency, blink rate, pupil dilation and eye opening size. Eye tracking data can include parameters related to a user's eyes, and can also include parameters related to time focusing on gaming content, time looking away from gaming content, and even characteristics such as intensity of a user's gaze. For example, one or more of pupil size, eye direction and eyelid opening size may be used to infer an intent gaze or non-interested gaze. According to embodiments, a gaming device can receive eye tracking inferences and/or monitor the eye tracking data for a player to make determinations about the effect that the game is having on the player. Detecting eye tracking data at block 210 can include determining lack of focus by monitoring player eye movements. Eye movement data, such as speed, frequency, and size of eye movements, can be used in determining the state of the player. Related data from eye tracking, such as blink rate, pupil dilation, and how wide open the player's eyes are can also be determined. Detecting eye tracking data at block 210 can include determining level of stress, boredom, tiredness of the player, and/or user's level of interest in the game play. Process 200 may include using eye tracking data to correlate a player's current state with presented communications.

According to embodiments, detecting eye tracking data at block 210 can include processing image data of a user, such as video data of a user's eyes, to assess one or more of user state and eye characteristics. By way of example, raw eye tracking data may be processed to determine where a user is looking and other parameters, such as the amount of pupil dilation, eye movement speed, and eye opening level. The processed eye data may be correlated with media that is being presented to determine user engagement and/or interaction with the media. Displayed objects a user is paying attention to may be identified. An example of engagement data can include if a user's eyes open wider when a particular action is shown in the media. The engagement and interaction data may be used to determine updates to make to the media presentation. Engagement and interaction data can also be used to effect game play when game media is played.

According to embodiments, machine learning models may use one or more eye movement models and training data sets characterizing, focused and unfocussed attention. Eye tracking models may include parameters to describing typical eye movements during a gaming session based on a game title, game style of play and game environment. In addition to eye tracking data, a model may be applied to user actions and data received based on user movement and biometrics.

At block 215, process 200 includes controlling, by the device, a presentation format for the electronic game content based on the user attention parameter, wherein the presentation format modifies the electronic game content presentation. Controlling the presentation format can include reducing output quality of at least one display area of the electronic game content based on the user attention parameter. For example, a first area may include a first resolution, such as the intended game resolution, and one or more second areas may each be controlled to include a display resolution. Controlling presentation format can include scaling display size of at least one electronic game element image. By way of example, a game controlled object, such as a character, vehicle or game element in general may be scaled to be larger or smaller compared to the regular display configuration.

Process 200 may optionally include detecting an environmental parameter at block 216. For example, process 200 may include detecting a sound level for an environment of the display device. When environmental sound is loud or in a busy environment, electronic audio features may be reduced or limited. For example, volume of game audio may be reduced. Similarly, directed sound output may be disabled or reduced.

At block 220, process 200 includes outputting, by the device, the electronic game content using the presentation format. Electronic game content may be output using one or more determined presentation formats for a period of time, and/or until user attention parameter indicates a user returning to focus. Output of the electronic game content includes controlling directive output of electronic game audio based on the sound level of the environment.

Process 200 may optionally include outputting a reward at optional block 222. For user focus that exceeds a period of time, meeting a threshold level for a period of time, or user focus parameter indicating maintained focus for a predetermined period of time, a device may control generating a reward. Controlling the presentation format may include output of a game reward. Rewards may be set or initiated by a user for training. For example, a user may specify a period of time as a training goal. A reward may be generated in response to user focus meeting a threshold level for a period of time, such as a user provided period of time.

Process 200 may optionally include updating a presentation format at optional block 223. The modified presentation format at block 220 may be presented by process 200 until a user regains focus. At block 223, process 200 can revert to a presentation format similar to block 205. Alternatively, process 200 can introduce one or more additional modifications. Additional modifications such as additional scaling, or reduced display areas for a user may be used in order to provide feedback that additional attention is required.

FIG. 3 illustrates a graphical representation of a device configuration according to one or more embodiments. Device 300 provides a configuration for a device configured for detecting and using user attention data for control and presentation of gaming content and interactive game control (e.g., game device 105). Device 300 and may relate to a gaming console, media device, and/or handheld device. Device 300 may be configured to present and modify gaming content using one or more user attention parameters. According to embodiments, device 300 includes sensor/eye tracking device 305, controller 310, and memory 315. Device 300 may also include an interface (e.g., network communication module, input/output (I/O) interface) 320. Device 300 may receive input from a user controller 325, which may be a game controller or a wearable device. Device 300 may output gaming content to a display using interface 320.

Controller 310 may relate to a processor or control device configured to execute one or more operations (e.g., executable instructions) stored in memory 315, such as processes for detecting and using user attention data for control and presentation of gaming content. Memory 315 may be non-transitory memory configured to provide data storage and working memory operations for device 300. Memory 315 may be configured to store computer readable instructions for execution by controller 310 for one or more processes described herein. Interface 320 may be a communications module configured to receive and transmit network communication data.

Device 300 may be configured to receive gaming media (e.g., card, cartridge, disk, etc.) and output visual and audio content of the gaming media to a display. For network games, device 300 may receive game data from a network source. Device 300 may be configured to receive input from one or more peripheral devices, such as sensor 305 and user controller 325.

Controller 310 may be configured to control presentation of gaming content, and detect eye tracking data for at least one user. Controller 310 may also be configured to update presentation of the gaming content using user attention data.

FIGS. 4A-4C are graphical representations of content quality scaling and attention tracking according to one or more embodiments. FIG. 4A illustrates a graphical representation of interactive game control functions according to one or more embodiments. According to embodiments, process 400 may be configured to control presentation format for the electronic game content based on user attention parameter for one or more users. A control device is configured to presenting electronic game content 401 on display 405. Electronic game content includes game element 410. According to embodiments, a user attention parameter may be used as an estimate of user focus and for controlling a presentation format of the electronic game content including modifying presentation of electronic game content. Process 400 includes modifying electronic game content 401 to generate modified electronic game content 402. Modified electronic game content 402 may be presented and/or output by display 405. According to embodiments, modified electronic game content 402 may include game element 410 modified to game element 411 having reduced size. By way of example, a game controlled object, such as a character, vehicle or game element in general, may be scaled to be larger or smaller compared to the regular display configuration. Reduction of game elements, or enlargement, are examples of scaling. As such, content may be highlighted based on interaction.

According to embodiments, modification of may include controlling the presentation format can include modifying output quality of at least one display area of the electronic game content based on the user attention parameter. At least one of audio and video components of electronic game content may be modified by a control device, such as scaling size of elements, controlling display resolution, controlling display of a portion of a screen and controlling directed audio. For example, a first area 412 may include a first resolution, such as the intended game resolution, and one or more second areas, such as areas 4151-n, may each be controlled to include a display resolution. Areas 4151-n may be shades of a display area that at blocked or partially blocked. Areas 4151-n may be vertical bars blocking or reducing the display focus of electronic game content. Although shown as vertical bars in FIG. 4A, areas 4151-n may be other shapes including horizontal bars, a single bar, a shape, pattern and/or a concentric pattern. Modifying electronic game content may be performed to highlight content based on a user's interaction with the game content.

FIG. 4B illustrates a graphical representation of interactive game control functions according to one or more embodiments. According to embodiments, process 420 may be configured to control presentation format for the electronic game content based on user attention parameter for one or more users. A control device is configured to presenting electronic game content 421 on display 405. A user attention parameter relative to the electronic game content includes focus point 425, detected in a first position. Focus point 425 is an exemplary position on display 405. Electronic game content includes audio outputs 4301-n including a first component (e.g., left component) and a second component (e.g., a right component). According to embodiments, a user attention parameter may be tracked, such as a user focus position or user focus area. Process 420 includes modifying electronic game content 421 to generate modified electronic game content 422. Modified electronic game content 422 may be presented and/or output by display 405. According to embodiments, modified electronic game content 422 may be modified based on detection of user focus point 426 in a second position, which may be determined as a position lacking focus. User focus point 426 is shown as an example, and may be detected as a position on display 405 or a position that is not associated with display 405. According to embodiments, audio output of an electronic game may be controlled to reduce output based on a user attention parameter, such as user focus point 426 being detected for a period of time. User focus point 426, for example, may not be associated with a display position of a use controlled game element or target game elements. Alternatively or in combination, audio outputs 4301-n may be muted or reduced when ambient or environmental sound is loud or above a predetermined threshold. In a loud environment, sound output may not be perceived. Similarly, directional sound output may be difficult to perceive due to ambient noise. Audio outputs 4301-n for electronic game content 422 may be reduced to reduce processing load on one or more of a control device and communication interface. A control device may be configured to provide focused sound such to reduce the directionality of sounds. For example, for game audio configured with a surround sound configuration (e.g., 360° around a user), the sounds coming from similar directions to the direction of the audio from the focused game object can be reduced, while audio from significantly different angles may not need to be adjusted to be differentiated from the audio from the focused game audio.

FIG. 4C illustrates a graphical representation of interactive game control functions according to one or more embodiments. According to embodiments, process 440 may be configured to control presentation format for the electronic game content based on user attention parameter for one or more users. A control device is configured to presenting electronic game content 441 on display 405. Process 440 includes modifying electronic game content 441 to generate modified electronic game content 442. According to embodiments, to incentivize user focus, one or more game rewards may be output for a user. Game rewards may similarly be generated in response to user completion of a goal, such as a user maintaining a user attention parameter for a period of time. Game content 411 may be presented and user focus point 455 may be detected. According to embodiments, maintaining a user focus point in a game area, such as game area 450 for a predetermined period of time, for an average amount of time over a time interval can earn a reward. According to embodiments, modified electronic game content 422 may output a reward by one or more of presenting a graphical element for reward 455 for display, an audio output, displayed message and notification in genera. Rewards can function as a system-wide currency can be used as in-game rewards for playing well or achieving goals, spent on system level items/games/traded.

While this disclosure has been particularly shown and described with references to exemplary embodiments thereof, it will be understood by those skilled in the art that various changes in form and details may be made therein without departing from the scope of the claimed embodiments.

What is claimed is:

1. A method for content quality scaling and attention tracking, the method comprising:
controlling, by a device, electronic game content presentation on a display;
detecting, by the device, a user attention parameter relative to the electronic game content, wherein the user attention parameter includes an estimate of user focus on the electronic game content presentation;
controlling, by the device, a presentation format for the electronic game content based on the user attention parameter, wherein the presentation format modifies the electronic game content presentation;
outputting, by the device, the electronic game content using the presentation format.

2. The method of claim 1, wherein the electronic game content is presented including at least one of audio and video content, and wherein the presentation format scales output of the at least one of the audio and video content.

3. The method of claim 1, wherein the user attention parameter is detected based on eye tracking data captured of a user during presentation of the electronic game content.

4. The method of claim 1, wherein the user attention parameter is determined based on at least one of camera data, eye tracking data, user accelerometer data, and content interaction data.

5. The method of claim 1, wherein the user attention parameter tracks user focus relative to at least one of a user controlled game element and a target of the electronic game.

6. The method of claim 1, wherein controlling the presentation format includes reducing output quality of at least one display area of the electronic game content based on the user attention parameter.

7. The method of claim 1, wherein controlling the presentation format includes scaling display size of at least one electronic game element image.

8. The method of claim 1, wherein controlling the presentation format includes output of a game reward, wherein the reward is generated in response to user focus meeting a threshold level for a period of time.

9. The method of claim 1, further comprising detecting a sound level for an environment of the display device, and controlling game content output based on environment detected.

10. The method of claim 9, wherein output of the electronic game content includes controlling directive output of electronic game audio based on the sound level of the environment.

11. A device configured for content quality scaling and attention tracking, the device comprising:
an interface configured to output gaming content;
a memory storing executable instructions; and
a controller coupled to the interface and the memory, wherein the controller is configured to
control electronic game content presentation on a display;
detect a user attention parameter relative to the electronic game content, wherein the user attention parameter includes an estimate of user focus on the electronic game content presentation;
control a presentation format for the electronic game content based on the user attention parameter, wherein the presentation format modifies the electronic game content presentation; and
output the electronic game content using the presentation format.

12. The device of claim 11, wherein the electronic game content is presented including at least one of audio and video content, and wherein the presentation format scales output of the at least one of the audio and video content.

13. The device of claim 11, wherein the user attention parameter is detected based on eye tracking data captured of a user during presentation of the electronic game content.

14. The device of claim 11, wherein the user attention parameter is determined based on at least one of camera data, eye tracking data, user accelerometer data, and content interaction data.

15. The device of claim 11, wherein the user attention parameter tracks user focus relative to at least one of a user controlled game element and a target of the electronic game.

16. The device of claim 11, wherein controlling the presentation format includes reducing output quality of at least one display area of the electronic game content based on the user attention parameter.

17. The device of claim 11, wherein controlling the presentation format includes scaling display size of at least one electronic game element image.

18. The device of claim 11, wherein controlling the presentation format includes output of a game reward, wherein the reward is generated in response to user focus meeting a threshold level for a period of time.

19. The device of claim 11, further comprising detecting a sound level for an environment of the display device, and controlling game content output based on environment detected.

20. The device of claim 19, wherein output of the electronic game content includes controlling directive output of electronic game audio based on the sound level of the environment.
